(19) United States
(12) Patent Application Publication
(10) Pub. No.: US 2025/0379808 A1
(43) Pub. Date: Dec. 11, 2025

(54) METHOD AND PACKET DETECTOR FOR DETECTING TARGET DETECTION PACKET

(71) Applicant: Realtek Semiconductor Corp., HsinChu (TW)

(72) Inventor: YING YANG, Suzhou City (CN)

(73) Assignee: Realtek Semiconductor Corp., HsinChu (TW)

(21) Appl. No.: 19/231,541

(22) Filed: Jun. 8, 2025

(30) Foreign Application Priority Data
Jun. 11, 2024 (CN) 202410751836.9

(51) Int. Cl. H04L 43/16; H04L 27/26

(52) U.S. Cl. CPC H04L 43/16; H04L 27/26

(57) ABSTRACT

A method and a packet detector for detecting a target detection packet are provided. The method includes: utilizing a match filter of the packet detector to perform match filtering on an input signal based on a reference sequence in order to generate a match filtering output, where the reference sequence corresponds to the target detection packet; utilizing a post-calculation circuit of the packet detector to perform calculation on the match filtering output to generate a calculation result; utilizing a comparator of the packet detector to compare the calculation result with a predetermine threshold to generate a comparison result; and determining whether the input signal is the target detection packet or not according to the comparison result.

### BACKGROUND OF THE INVENTION

### 1. Field of the Invention

The present invention is related to packet detection, and more particularly, to a method and a packet detector for detecting a target detection packet such as an orthogonal frequency-division multiplexing (OFDM) packet.

### 2. Description of the Prior Art

As a preamble signal is transmitted in a fixed sequence at the beginning of an orthogonal frequency-division multiplexing (OFDM) packet, it is typical to utilize specific signal processing methods to detect the preamble signal in order to determine whether an OFDM packet is received or not. When some types of interference signals are received and processed by these specific signal processing methods, however, these interference signals may also meet the detection conditions for detecting the OFDM packet set by the related technology, resulting in them being mistakenly identified as OFDM packets.

Thus, there is a need for a novel method and associated architecture which can solve the problem of mistakenly identifying specific types of interference signals as an OFDM packet.

### SUMMARY OF THE INVENTION

An objective of the present invention is to provide a method and a packet detector for detecting a target detection packet such as an orthogonal frequency-division multiplexing (OFDM) packet, in order to solve the problem of the related art without introducing any side effect or in a way that is less likely to introduce side effects.

At least one embodiment of the present invention provides a method for detecting a target detection packet, where the method is applicable to a packet detector. The method comprises: utilizing a match filter of the packet detector to perform match filtering on an input signal based on a reference sequence to generate a match filtering output, wherein the reference sequence corresponds to the target detection packet; utilizing a post-calculation circuit of the packet detector to perform calculation on the match filtering output to generate a calculation result; utilizing a comparator of the packet detector to compare the calculation result with a predetermined threshold to generate a comparison result; and determining whether the input signal is the target detection packet or not according to the comparison result.

At least one embodiment of the present invention provides a packet detector for detecting a target detection packet. The packet detector comprises a match filter, a post-calculation circuit and a comparator, where the post-calculation circuit is coupled to the match filter, and the comparator is coupled to the post-calculation circuit. The match filter is configured to perform match filtering on an input signal based on a reference sequence to generate a match filtering output, where the reference sequence corresponds to the target detection packet. The post-calculation circuit is configured to perform calculation on the match filtering output to generate a calculation result. The comparator is configured to compare the calculation result with a predetermined threshold to generate a comparison result. The packet detector determines whether the input signal is the target detection packet or not according to the comparison result.

The method and the packet detector provided by the embodiments of the present invention perform further calculations on the match filtering output, such that a peak of the calculation result obtained under a condition where the input signal is the target detection packet can be significantly greater than a peak of the calculation result obtained under a condition where the input signal is a single-frequency signal. Therefore, by properly setting the predetermined threshold, the packet detector can effectively prevent the single-frequency signal from being mistakenly identified as the target detection packet. In addition, the embodiment of the present invention will not greatly increase additional costs. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an operating principle of a match filter according to an embodiment of the present invention.

FIG. 2 is a diagram illustrating a packet detector according to an embodiment of the present invention.

FIG. 3 is a diagram illustrating a calculation result obtained by a packet detector based on a first calculation scheme according to an embodiment of the present invention.

FIG. 4 is a diagram illustrating a calculation result obtained by a packet detector based on a second calculation scheme according to an embodiment of the present invention.

FIG. 5 is a diagram illustrating a working flow of a method for detecting a target detection packet according to an embodiment of the present invention.

### DETAILED DESCRIPTION

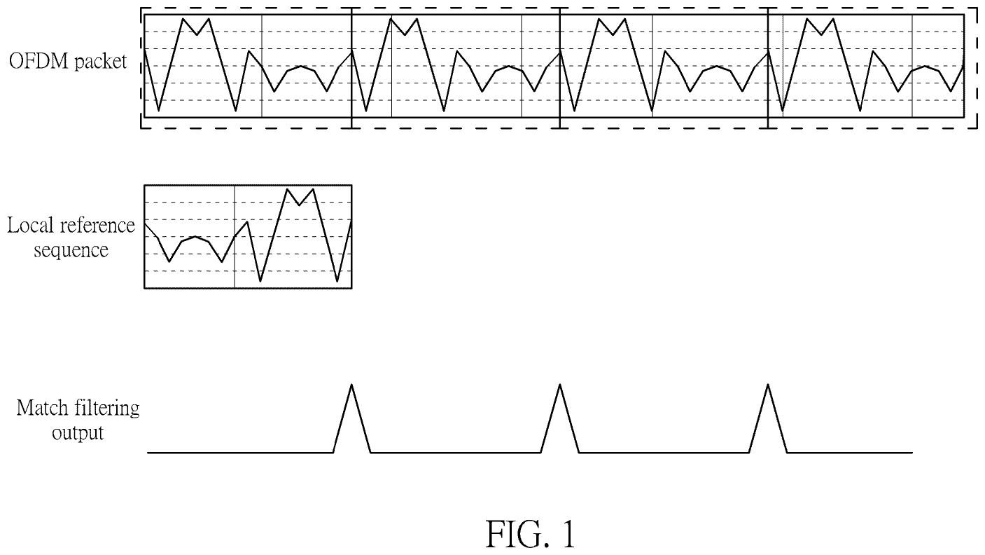

FIG. 1 is a diagram illustrating an operating principle of a match filter according to an embodiment of the present invention, where FIG. 1 shows an orthogonal frequency-division multiplexing (OFDM) packet received by the match filter, a preset local reference sequence (e.g. match filter coefficients that are pre-configured), and a match filtering output generated by the match filter performing match filtering on the OFDM packet based on the local reference sequence. Operations of the match filter mentioned above may be expressed by the following equations.

$${m}_{Z k} = {\sum }_{i = 1}^{{N}_{R X} - 1} weightM {F}_{i} \times {\sum }_{t = 1}^{τ - 1} {\vert buffer [ i ] [ t ] \times {s}_{i , t} \vert}^{2}$$

Note that m_{Zk} is the match filtering output, N_{RX} is a number of receiver antennas, τ=T_{period}/T_{sampling}, T_{period} is a length of an OFDM symbol (e.g. 0.8 μs in a short training field (L-STF)), T_{sampling} is a data sampling rate, weightMFᵢ is a weighting value of an i^{th} antenna, s_{i,t} is a match filter coefficient (which is a quantified L-STF waveform with a sampling rate corresponding to a bandwidth), and buffer[i][t] is an input signal received by the match filter.

Based on the above operation, when a signal received by the match filter has a header field that matches the local reference sequence, the match filtering output may have periodic peaks, as illustrated by a waveform of the match filtering output shown in FIG. 1. In this embodiment, conditions for determining that this signal is an OFDM packet are as follows: (1) an interval between two consecutive peaks is a predetermined length (e.g. 0.8 μs); and (2) there is a null value at a specific position between these two peaks.

When both of the above conditions are met, it can be determined that this signal is an OFDM packet (i.e. the OFDM packet is detected), and a subsequent processing procedure for this OFDM packet is initiated.

It should be noted that, when the signal received by the match filter is a single-frequency signal with sufficient power, the output of the match filter may remain at a specific level without significant level variations (e.g. staying below a predetermined threshold). In this case, the peaks mentioned above will not be detected and it may be determined that the match filter does not receive an OFDM packet. When, however, the signal received by the match filter is a single-frequency signal with lower power, the output of the match filter may have random and large level variations due to noise (e.g. frequent occurrences of conditions exceeding the predetermined threshold), leading the system to mistakenly identify this signal as an OFDM packet.

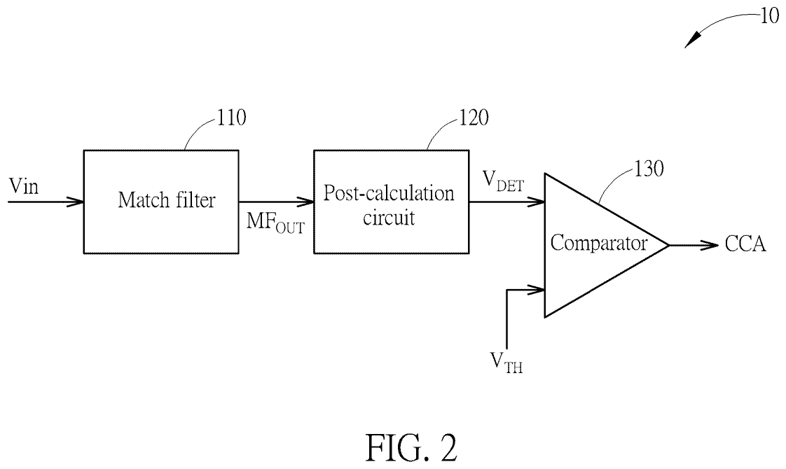

FIG. 2 is a diagram illustrating a packet detector 10 according to an embodiment of the present invention, where the packet detector 10 is configured to detect whether an input signal Vin is a target detection packet (e.g. an OFDM packet) or not. As shown in FIG. 2, the packet detector 10 comprises a match filter 110, a post-calculation circuit 120 and a comparator 130, where the post-calculation circuit 120 is coupled to the match filter 110, and the comparator 130 is coupled to the post-calculation circuit 120. In this embodiment, the match filter 110 is configured to perform match filtering on the input signal Vin based on a reference sequence (e.g. the local reference sequence shown in FIG. 1) to generate a match filtering output MF_{OUT}, where the reference sequence corresponds to the target detection packet. The post-calculation circuit 120 is configured to perform calculation on the match filtering output MF_{OUT} to generate a calculation result V_{DET}, and the comparator 130 is configured to compare the calculation result V_{DET} with a predetermined threshold V_{TH} to generate a comparison result CCA. More particularly, the packet detector 10 can determine whether the input signal Vin is the target detection packet according to the comparison result CCA.

As mentioned above, when the packet detector 10 determines whether the input signal Vin is an OFDM packet based on level change of the match filtering output MF_{OUT} output from the match filter 110, the packet detector 10 may mistakenly determine that an OFDM packet is received while the packet detector 10 actually receives interference of a single-frequency signal. Thus, the present invention utilizes the post-calculation circuit 120 to perform further calculation on the match filtering output MF_{OUT} in order to make a peak of the calculation result V_{DET} when the input signal Vin is the OFDM packet be greater than a peak of the calculation result V_{DET} when the input signal Vin is the single-frequency signal. In this way, by properly setting the predetermined threshold V_{TH}, the comparator 130 can effectively distinguish between a condition where the input signal Vin is the OFDM packet and a condition where the input signal Vin is the single-frequency signal. For example, when the comparison result CCA indicates that the calculation result V_{DET} is periodically (e.g. with a fixed cycle period of 0.8 μs) greater than the predetermined threshold V_{TH}, the packet detector 10 may determine that the input signal Vin is the OFDM packet. When the comparison result CCA indicates that the calculation result V_{DET} is continuously less than the predetermined threshold V_{TH} (or the period of the calculation result V_{DET} exceeding the predetermined threshold V_{TH} does not match a predetermined value such as 0.8 μs), the packet detector 10 may determine that the input signal Vin is not the OFDM packet.

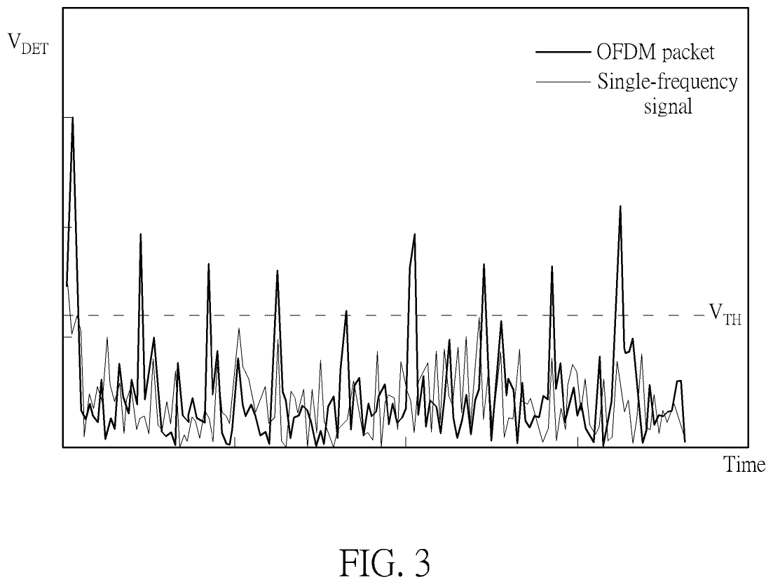

FIG. 3 is a diagram illustrating the calculation result V_{DET} obtained by the packet detector 10 based on a first calculation scheme according to an embodiment of the present invention. As the match filtering output MF_{OUT} obtained under the condition where the input signal Vin is a single-frequency signal contains a direct current (DC) component, the post-calculation circuit 120 may reduce or remove the DC component from the match filtering output MF_{OUT} to lower peak values of the match filtering output MF_{OUT}. Specifically, the post-calculation circuit 120 may perform low-pass filtering on the match filtering output MF_{OUT}, more particularly, by calculating a present value MF_{dc} (t) of a low-pass filtering result MF_{dc} according to a previous value MF_{dc} (t−1) of the low-pass filtering result MF_{dc}, a present value MF_{OUT}(t) of the match filtering output MF_{OUT} and a preset parameter. In addition, the post-calculation circuit 120 may further generate a present value of the calculation result V_{DET} according to the present value MF_{dc} (t) of the low-pass filtering result MF_{dc} and the present value MF_{OUT}(t) of the match filtering output MF_{OUT}. For example, MF_{dc} (t)=MF_{dc} (t−1)×(1−α)+MF_{OUT}(t)×α, and MF_{rmvdc} (t)=MF_{OUT}(t)−MF_{dc} (t), where MF_{rmvdc} (t) may represent the present value of the calculation result V_{DET}. By the above calculation, as long as the predetermined threshold V_{TH} is properly set, the calculation result V_{DET} obtained under the condition where the input signal Vin is the single-frequency signal can be effectively reduced (with its peaks remaining below the predetermined threshold V_{TH}), while the calculation result V_{DET} obtained under the condition where the input signal Vin is the OFDM packet can still exceed the predetermined threshold V_{TH}, allowing the packet detector 10 to determine that the input signal Vin is the OFDM packet and trigger subsequent packet processing procedures.

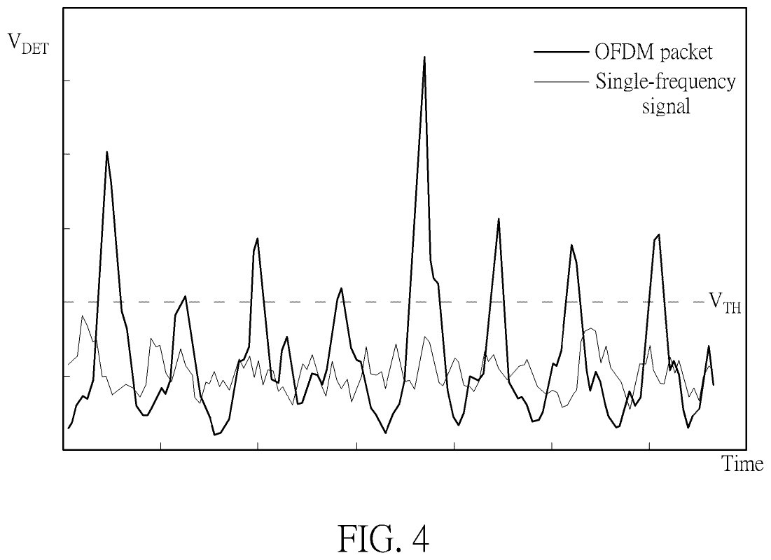

FIG. 4 is a diagram illustrating the calculation result V_{DET} obtained by the packet detector 10 based on a second calculation scheme according to an embodiment of the present invention. The post-calculation circuit 120 may sum multiple values of the match filtering output MF_{OUT} over a first time interval to generate a first summation result, and sum multiple values of the match filtering output MF_{OUT} over a second time interval to generate a second summation result. In this embodiment, the post-calculation circuit 120 may calculate a ratio of the second summation result to the first summation result in order to generate the calculation result V_{DET}. As the match filtering output MF_{OUT} obtained under the condition where the input signal Vin is the single-frequency signal fluctuates randomly around a specific value but does not exhibit regular peaks, the first summation result and the second summation result are close to each other (i.e. the ratio between them is close to 1). In contrast, as the match filtering output MF_{OUT} obtained under the condition where the input signal Vin is the OFDM signal may exhibit regular peaks, when the first time interval does not include the peak of the match filtering output MF_{OUT} but the second time interval includes the peak of the match filtering output MF_{OUT}, the second summation result may be greater than the first summation result, causing the ratio between them to increase. The related calculation may be expressed as follows:

$$M {F}_{s u m} ( t ) = {\sum }_{n = t - T}^{t} M {F}_{o u t} ( n )$$

$${V}_{D E T} = \frac{M {F}_{s u m} ( t )}{M {F}_{s u m} ( t - T )}$$

As shown above, the post-calculation circuit 120 may sum values of the match filtering output MF_{OUT} from a time point (t−T) to a time point t to obtain a summation result MFₛᵤₘ (t) at the time point t. Deduced by analogy, the post-calculation circuit 120 may obtain a summation result MFₛᵤₘ (t−T) at the time point (t−T), and therefore calculate the ratio between MFₛᵤₘ(t) and MFₛᵤₘ (t−T) to obtain the calculation result V_{DET}. As shown in FIG. 4, when the input signal Vin is the single-frequency signal, the calculation result V_{DET} merely fluctuates slightly around a specific value (e.g., 1) without exceeding the predetermined threshold V_{TH}. In comparison, when the input signal Vin is the OFDM packet, periodic peaks of the calculation result V_{DET} may exceed the predetermined threshold V_{TH}, allowing the packet detector 10 to determine that the input signal Vin is the OFDM packet.

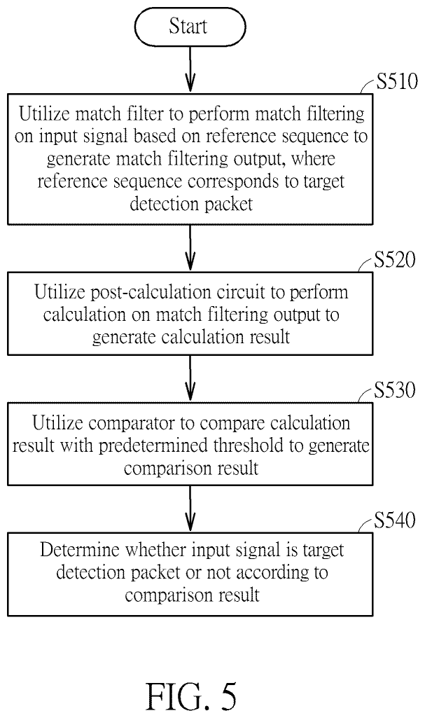

FIG. 5 is a diagram illustrating a working flow of a method for detecting a target detection packet (e.g. the OFDM packet) according to an embodiment of the present invention, wherein the method is applicable to a packet detector (e.g. the packet detector 10 shown in FIG. 2). It should be noted that the working flow shown in FIG. 5 is for illustrative purposes only, and is not meant to be a limitation of the present invention. For example, one or more steps may be added, deleted or modified in the working flow shown in FIG. 5. In addition, if a same result can be obtained, these steps do not have to be executed in the exact order shown in FIG. 5.

In Step S510, the packet detector may utilize a match filter thereof to perform match filtering on an input signal based on a reference sequence to generate a match filtering output, where the reference sequence corresponds to the target detection packet.

In Step S520, the packet detector may utilize a post-calculation circuit thereof to perform calculation on the match filtering output to generate a calculation result.

In Step S530, the packet detector may utilize a comparator thereof to compare the calculation result with a predetermined threshold to generate a comparison result.

In Step S540, the packet detector may determine whether the input signal is the target detection packet or not according to the comparison result.

To summarize, the method and the packet detector provided by the embodiments of the present invention can further process the output of the match filter, such that the processed result is effectively reduced when the input signal is the single-frequency signal, while the processed result still maintains sufficiently high peaks for proper detection when the input signal is the OFDM packet. Moreover, the embodiments of the present invention will not greatly increase additional costs. Thus, the present invention can solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a target detection packet, wherein the method is applicable to a packet detector, and the method comprises:
utilizing a match filter of the packet detector to perform match filtering on an input signal based on a reference sequence to generate a match filtering output, wherein the reference sequence corresponds to the target detection packet;
utilizing a post-calculation circuit of the packet detector to perform calculation on the match filtering output to generate a calculation result;
utilizing a comparator of the packet detector to compare the calculation result with a predetermined threshold to generate a comparison result; and
determining whether the input signal is the target detection packet or not according to the comparison result.

2. The method of claim 1, wherein a peak of the calculation result when the input signal is the target detection packet is greater than a peak of the calculation result when the input signal is a single-frequency signal.

3. The method of claim 1, wherein the step of determining whether the input signal is the target detection packet according to the comparison result comprises:
in response to the calculation result being periodically greater than the predetermined threshold, determining that the input signal is the target detection packet.

4. The method of claim 1, wherein the step of determining whether the input signal is the target detection packet according to the comparison result comprises:
in response to the calculation result being continuously less than the predetermined threshold, determining that the input signal is not the target detection packet.

5. The method of claim 1, wherein the step of utilizing the post-calculation circuit of the packet detector to perform calculation on the match filtering output to generate the calculation result comprises:
calculating a present value of a low-pass filtering result according to a previous value of the low-pass filtering result, a present value of the match filtering output and a preset parameter; and
generating a present value of the calculation result according to the present value of the low-pass filtering result and the present value of the match filtering output.

6. The method of claim 1, wherein the present value of the low-pass filtering result is MF_{dc} (t), the previous value of the low-pass filtering result is MF_{dc} (t−1), the present value of the match filtering output is MFₒᵤₜ (t), the preset parameter is α, the calculation result is MF_{rmvdc} (t), MF_{dc} (t)=MF_{dc} (t−1)×(1−α)+MFₒᵤₜ (t)×α, and MF_{rmvdc} (t)=MFₒᵤₜ (t)−MF_{dc} (t).

7. The method of claim 1, wherein the step of utilizing the post-calculation circuit of the packet detector to perform calculation on the match filtering output to generate the calculation result comprises:
summing multiple values of the match filtering output over a first time interval to generate a first summation result;
summing multiple values of the match filtering output over a second time interval to generate a second summation result; and
calculating a ratio of the second summation result to the first summation result to generate the calculation result.

8. A packet detector for detecting a target detection packet, comprising:
a match filter, configured to perform match filtering on an input signal based on a reference sequence to generate a match filtering output, wherein the reference sequence corresponds to the target detection packet;
a post-calculation circuit, coupled to the match filter, configured to perform calculation on the match filtering output to generate a calculation result; and
a comparator, coupled to the post-calculation circuit, configured to compare the calculation result with a predetermined threshold to generate a comparison result;
wherein the packet detector determines whether the input signal is the target detection packet or not according to the comparison result.

9. The packet detector of claim 8, wherein a peak of the calculation result when the input signal is the target detection packet is greater than a peak of the calculation result when the input signal is a single-frequency signal.

10. The packet detector of claim 8, wherein when the calculation result is periodically greater than the predetermined threshold, the packet detector determines that the input signal is the target detection packet.

11. The packet detector of claim 8, wherein when the calculation result is continuously less than the predetermined threshold, the packet detector determines that the input signal is not the target detection packet.

12. The packet detector of claim 8, wherein the post-calculation circuit calculates a present value of a low-pass filtering result according to a previous value of the low-pass filtering result, a present value of the match filtering output and a preset parameter, and generates a present value of the calculation result according to the present value of the low-pass filtering result and the present value of the match filtering output.

13. The packet detector of claim 8, wherein the present value of the low-pass filtering result is MF_{dc} (t), the previous value of the low-pass filtering result is MF_{dc} (t−1), the present value of the match filtering output is MFₒᵤₜ (t), the preset parameter is α, the calculation result is MF_{rmvdc} (t), MF_{dc} (t)=MF_{dc} (t−1)×(1−α)+MFₒᵤₜ (t)×α, and MF_{rmvdc} (t)=MFₒᵤₜ (t)−MF_{dc} (t).

14. The packet detector of claim 8, wherein the post-calculation circuit sums multiple values of the match filtering output in a first time interval to generate a first summation result, sums multiple values of the match filtering output in a second time interval to generate a second summation result, and calculates a ratio of the second summation result to the first summation result to generate the calculation result.
